(19) United States
(12) Patent Application Publication
(10) Pub. No.: US 2014/0164022 A1
(43) Pub. Date: Jun. 12, 2014

(54) Patient Directed Healthcare System

(71) Applicant: Atlantic Health System, Inc., a NJ non-profit corporation, Morristown, NJ (US)

(72) Inventors: Linda Reed, Morristown, NJ (US); William D. Neigher, Chester, NJ (US)

(73) Assignee: Atlantic Health System, Inc., a NJ non-profit corporation, Morristown, NJ (US)

(21) Appl. No.: 14/101,879

(22) Filed: Dec. 10, 2013

Related U.S. Application Data
(60) Provisional application No. 61/735,414, filed on Dec. 10, 2012.

(51) Int. Cl. G06F 19/00

(52) U.S. Cl. CPC G06F 19/322
USPC 705/3

(57) ABSTRACT

The present invention provides a system allowing an individual to actively manage, oversee, direct, and interact with their healthcare. Specifically, the present invention provides a system that allows for the continuous input of updated information from the team of healthcare providers and the patient with full access to the patient history all with real time continuous analysis to provide feedback of likely critical data to consider in the decision of next best steps to provide the only participant whose only motive is to get better as expeditiously as possible with the knowledge necessary to actively manage, oversee and direct their own healthcare. In particular, the present invention provides a system whereby the individual's personal health records are selectively inputted and shared with others and compared with databases of stored information, and the information returned is used by the individual, or others to provide efficient healthcare and manage public health emergencies.

This application claims priority to Provisional U.S. Patent Application Ser. No. 61/735,414, filed Dec. 10, 2012.

### FIELD OF THE INVENTION

The present invention provides a system for allowing an individual to actively manage, oversee, direct and interact regarding their healthcare. At present, the principal participants managing, overseeing and directing patient healthcare are healthcare providers and insurance companies, thus leaving out the individual with the greatest interest and the only participant whose only motive is to avoid the need for healthcare and/or to get better as expeditiously as possible. In particular, the present invention provides a personal communication device (a “PCD”) and system whereby individuals can actively manage, oversee and direct their healthcare by way of the continuous input and exchange of updated information from the individual, healthcare providers and other stakeholders. The device and system of the present invention provides access to the patient's health history and personal electronic health record (“PHR”), patient symptoms and other relevant facts such as personal history and tendencies, other information and services, and analysis of same, all with the ability for real time analysis to provide both non-critical preventative recommendations and resources and critical recommendations and resources when necessary or recommendable. The device and system of the present invention compiles a database of PHR information to enable caregivers across a continuum of the healthcare process, from pre-admission, during admission, and post-admission, to provide more effective and comprehensive care with full patient and/or patient representative monitoring. The present invention also provides a device and system whereby the individual's PHR is selectively and securely inputted and shared with others, such as, for example, healthcare providers, laboratories, insurance companies, public health officials and compared with databases of stored information, and the information returned is used by the individual, together with others, to maximize management of the individual's healthcare and provide for efficient management of public health emergencies. The clinical integration associated with the device and system of the present invention helps prevent errors that would otherwise occur from the absence of such integration.

### BACKGROUND

The expansion and availability of computing power, particularly in connection with PCD's and the internet, the advent of user interfaces and social media and the ease of access to reliable information via the internet, have resulted in individuals being capable of and demanding a more active role in their healthcare in connection with healthcare decisions heretofore reserved for health care professionals and insurance company stakeholders. Recent studies have concluded that involving patients as qualified partners in co-producing health care is a positive development that health care provider services need to embrace.

To date, the principal stakeholders with decision-making authority and power over a patient's healthcare are the physician, the hospital and the insurance company. While those stakeholders have patient wellness as a material goal, those stakeholders also necessarily subject to business, market and regulatory forces. The only participant whose single-minded motivation is to get well as expeditiously as possible is the patient and until now, patients have only had a limited and indirect ability to manage, oversee and direct their own health care decisions. The present invention provides the means and “artificial intelligence” necessary to raise the individual's “medical IQ” such that they are capable of more material input and oversight into their care at levels that were heretofore impossible unless the patient was also a physician in the particular area of the illness.

While advances in electronic healthcare records have brought marked improvements to the efficient transfer of medical information amongst multiple healthcare providers, simply granting the patient access to those records does not inherently empower the patient to take an active role in their own healthcare or even improve healthcare. Rather it is vital to build a database of electronic healthcare records over time in order to supply caregivers across a continuum of healthcare provision of services with information sufficient for providing more effective care. Caregivers and medical experts need to be able to understand the information regardless of its language or formatting or coding. The information needs to be easily transportable across geographic boundaries in an effort to clinically integrate different care providers while maintaining full regulatory compliance.

Recent technological advances such as greater access to computing power, reliable information and knowledge (in part because of increasing use and availability of technology, social media and social changes), experience with self-management programs and new legal requirements for patient involvement have all contributed to creating a new dynamic through which patients and citizens are redefining their roles as informed consumers in relation to health and social care. For example, rendering the individual capable of determining the relative merit, advisability and implications of proposed tests and procedures.

For example, individuals, particularly those living with a health condition, or those who desire to prevent health conditions and to take an active role in maintaining their own health, track data including for example, data relating to allergies and adverse drug reactions, chronic diseases, family and personal medical history, illnesses and hospitalizations, imaging reports (such as, for example, X-rays, CT scans, MRI and the like), laboratory test results, medications and dosing, prescription records, surgeries and other procedures, vaccinations, observations of daily living (ODLs), and the like. Such a wealth of information is important in the management of the individual's healthcare and can be useful to others who may not be familiar with the individual, or their past health history, such as, for example, the individual's attending physician at a hospital. However, such information frequently does not get shared with others, may be overlooked, or may be stored in a manner that is not easily accessible, either by the individual or others, leading to incorrect diagnosis and treatment. Preventing this incorrect diagnosis and treatment therefore remains a vital goal, one that can be accomplished through increased clinical integration. Sharing patient information through virtual transportation of information with a patient can serve to satisfy the clinical integration aim while allowing the patient to monitor the completeness and security of such information.

Individuals are able to utilize the internet to consult with healthcare professionals (such as, for example, via the service disclosed in the website www.mdlivecare.com, offered under the trademark MDLIVE™, or via the service disclosed in the website www.hellohealth.com, offered under the trademark HELLOHEALTH®). Individuals are also able merge their health records (either manually or by logging into their accounts at partnered health services providers) into a centralized health profile, by using, for example, the service formally offered at and disclosed by GOOGLEHEALTH™.

However, the principal participants with decision-making power over a patient's healthcare are and have been the health care providers, hospitals and insurance companies. While all such participants ostensibly have patient wellness as a material goal, all participants are also necessarily subject to business, market and regulatory forces. For example, both the hospital and insurance company can only continue to provide their valuable services if they maintain profitability and stay in business. Physicians have malpractice considerations as well as being personally remunerated based on the number of procedures performed. The only participant whose single pure motivation is to get well as expeditiously as possible is the patient and until now, only had the ability to manage, oversee and direct their own health care decisions with limited ability. Even new technologies tend to leave out this all important participant.

For example, U.S. Pat. No. 7,953,699 titled, SYSTEM FOR THE PROCESSING OF INFORMATION BETWEEN REMOTELY LOCATED HEALTHCARE ENTITIES which issued May 31, 2011 discloses “systems and methods for reconciling healthcare data between multiple distributed computing nodes that enable an individual node, a topic object, or an intelligent agent to determine synchronization with other nodes, comprising sending source node data to a payload generator, the source node data including difference data, an encapsulated topic object, or intelligent agent communications, generating a payload including the source node data and destination attributes, and sending the payload to a destination node, topic object, or destination intelligent agent, and using the source node data to update destination node data according to destination node, topic object, or destination intelligent agent requirements.

In another example, U.S. Pat. No. 7,885,822 titled, SYSTEM AND METHOD FOR ELECTRONIC MEDICAL FILE MANAGEMENT which issued Feb. 8, 2011 discloses, “a system for transferring electronic medical files is provided, such as for providing for patient file integrity and continuity in a telemedicine system. The system includes a record server that has a medical record data file for each patient, wherein each patient's medical record data file holds medical record data for that patient. A record client coupled to the record server receives the medical record data file. The medical record data is encapsulated to prevent modification of the medical record data, thus providing for integrity and continuity of the patient's medical record.”

In another example, U.S. Application No. 2012/0101849 titled VIRTUAL CARE TEAM RECORD FOR TRACKING PATIENT DATA, which published Apr. 26, 2012 discloses, “a system and method for managing healthcare information is disclosed. The data servers each include a data manager that comprises a controller, applications, an application manager, a virtual care team module, and a user interface engine. The controller manages the core functions and the transmission of data between data manager components. The applications are applications that are created by the user or downloaded as third-party applications. The application manager manages the creation and communication between applications. The virtual care team module manages the transmission of patient data between data servers. The user interface engine generates user interfaces for displaying the applications and collecting clinical trial data.”

There are also patents that assist healthcare providers in making more efficient diagnoses and decisions. For example, U.S. Pat. No. 8,548,827 titled COMPUTER-IMPLEMENTED METHOD FOR MEDICAL DIAGNOSIS SUPPORT, issued Oct. 1, 2013 discloses, “a computer-implemented method for medical diagnosis support for patient data of a patient through a data processing system, Wherein the data processing system comprises a graphical user interface and a database contain ing rules for calculating diagnosis risks.”

In another example, a disclosure at ISABELHEALTHCARE.COM discloses, “Accessed directly or fully integrated with an EMR system, the web-based Isabel tool uses the patient's demographics and clinical features to produce a list of possible diagnoses, including time-sensitive ‘Don't Miss Diagnoses.’ The tool integrates knowledge resources from leading publishers, together with local resources, to form a unique and practical knowledge organizer”

In another example, U.S. Pat. No. 7,379,885, titled SYSTEM AND METHOD FOR OBTAINING, PROCESSING AND EVALUATING PATIENT INFORMATION FOR DIAGNOSING DISEASE AND SELECTING TREATMENT, issued May 27, 2009 discloses, “A computer-based system and method which constructs medical histories by direct interactions between the patient and system that acquires pertinent and relevant medical information covering the complete life of a given patient. The system and method insure that a complete life long medical history is acquired from every patient interacting with the health care system. Once acquired, the facts of the patient's life long and family medical history are analyzed automatically by databases to generate a set of the most reasonable diagnostic possibilities (the differential diagnosis) for each medical problem identified and for each risk factor for disease that is uncovered in the historical database. Further, the automatically analyzed database of historical medical information is used as the search tool for bringing to bear, on the diagnosis and treatment of each medical problem identified in each patient, the entirety of medical knowledge that relates to and can be useful for the correct and efficient diagnosis and treatment of each of every patient's medical problems. This collection of information is analyzed to generate a final diagnosis and treatment regimen.”

There remains, therefore an unmet need for a device and system that allows an individual to actively manage, oversee and direct their healthcare, and that allows an individual to selectively and securely share and discuss their personal health records with others, such as, for example, healthcare providers, in a manner that educates and empowers the individual to manage their healthcare and enhances prevention, diagnosis, treatment and prognosis, all increasing overall health. The present invention also allows an individual to access and share all information relevant to their healthcare and consequently provide better information to health care providers and make a more informed decision, based on all facts and patient desires. The present invention also provides public health officials an efficient mechanism to learn of and manage public health concerns and emergencies.

### SUMMARY

The present invention provides a solution to the unmet need, by providing a system that allows an individual to manage, oversee and direct their healthcare comprising a patient interface and an at least one node selected from the group consisting of:
a) an at least one patient healthcare record database;
b) an at least one healthcare facility database;
c) an at least one patient individual complaint database;
d) an at least one billing database;
e) an at least one other user interface;
f) access to healthcare facility services; and
g) access to the internet;
   wherein the patient interface provides: (i) access to the at least one selected node; and (ii) continuous analysis based on the individual's input to all of the foregoing to provide output of likely critical and non-critical information to consider in formulating a diagnosis, plan of treatment, or other healthcare or personal decisions.

In one embodiment, the patient interface is an application on a personal communication device.

Each of the elements of the system of the present invention can be thought of as nodes. For example, the patient interface is the central node connecting with and interacting with each other node. Other nodes include hospital services, including for example, dining options, television options, nurse's station and the like; the healthcare facility database, including for example, the hospitals records such as billing, patient history within that hospital, complete patient history, patient family history, medical library database and the like; the patient complaint database including for example the patient's specific itemized illness, where it hurts, pain score, and the like; the patient healthcare record database including for example, the patient's electronic health records history, family medical history, personal tendencies and the like; and the internet.

In one embodiment, the patient healthcare record database contains files and an engine such that the files may be translated into different languages, formatting and health codes.

In one embodiment, the individual utilizes the patient interface to access information stored in any node.

In one embodiment, the individual has read only access to one, or more than one of the databases accessed via the system of the present invention.

In one embodiment, the individual has read and write access to one, or more than one of the databases accessed via the system of the present invention. In one embodiment, the individual has read and write access to the at least one individual complaint database only. In one embodiment, read-write access to the at least one healthcare records database requires a verification step, prior to any change to the information stored therein. In one embodiment, only the individual's healthcare provider may make changes to the information stored in the at least one healthcare records database.

In one embodiment, the individual utilizes the patient interface to communicate with and to access communications with the individual's healthcare providers.

In one embodiment, the individual utilizes the patient interface to access information stored in any of the connected databases and/or the internet, including databases in geographic locations different from that of the individual and databases with information stored years in advance of the present year.

In one embodiment, the individual utilizes the patient interface to access and request hospital services, for example to call the nurse or order dinner.

In one embodiment, the patient interface is able to access all available features, such as, for example, entertainment services (for example, TV, radio and the like), communications (telephone, email, for example), a call button, order food, update their social media allowing selected others to view their current condition, or receive messages or gifts from others.

In one embodiment, the individual utilizes the patient interface to access and evaluate different forms of medication utilized over varying periods of time, medication interactions, expected efficacy and the like.

### BRIEF DESCRIPTION OF THE DRAWINGS

FIG. 1 depicts a representation of the home screen of a PCD capable of allowing access to one embodiment of the present invention. Specifically, and not by way of limitation, an APPLE® IPHONE® screen is depicted with an icon for accessing the downloaded application.

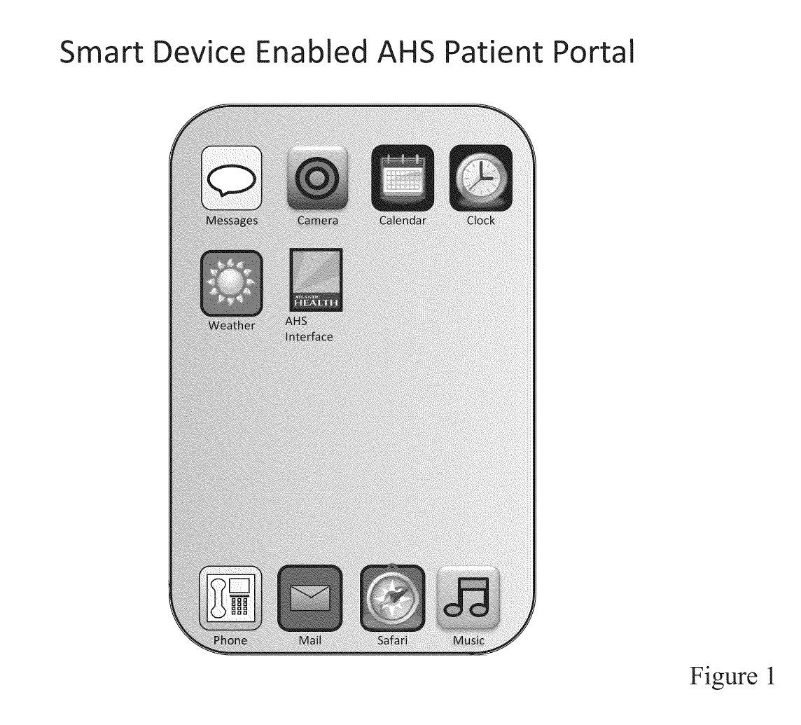

FIG. 2 depicts a representation of a next screen of the PCD prompting the user to either register or login.

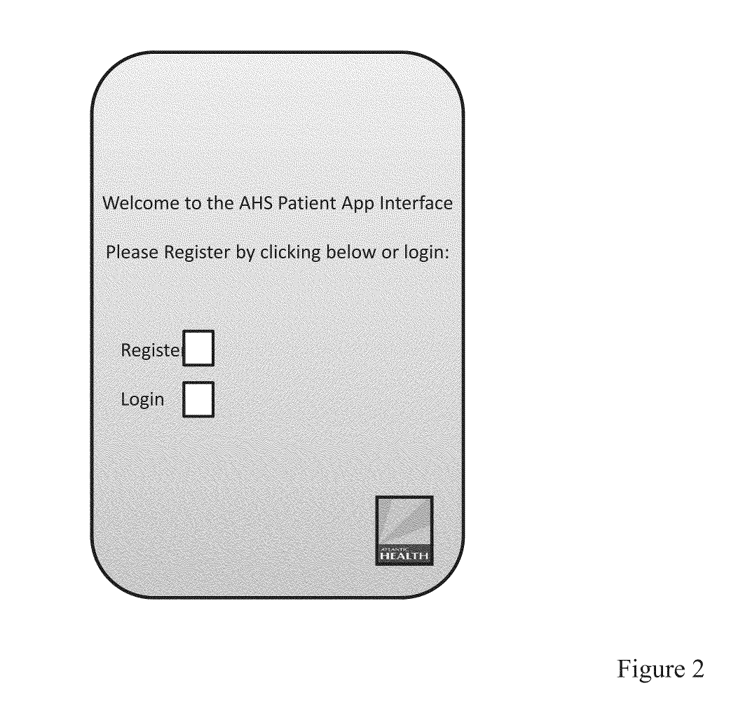

FIG. 3 depicts a representation of a next screen of the PCD prompting the user to login under the assumption that they have already registered, with an option for the application to remember the user on this PCD.

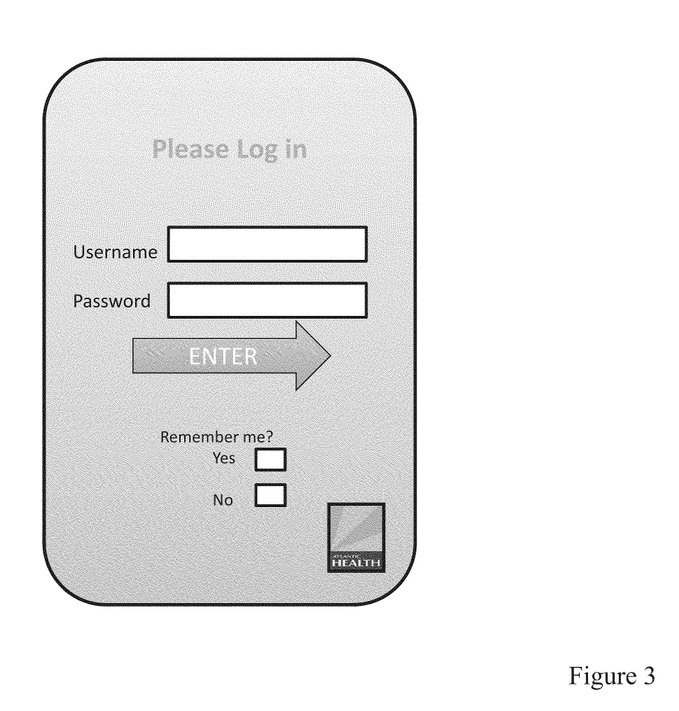

FIG. 4 depicts a representation of a screen of the PCD that represents a patient interface portal screen allowing access to the various patient specific databases and action entry screens.

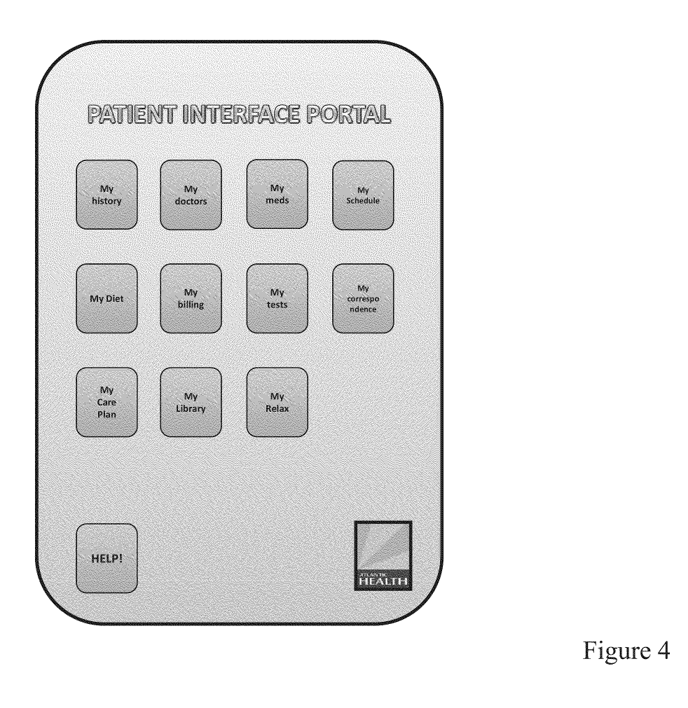

FIG. 5 depicts a representation of one of many next screens of the PCD depending on menu navigation, specifically in this instance, and again not by way of limitation, a “my history” screen, allowing the patient to access his historical conditions, his medical charts, his pain score, his entry of a new complaint, his bio and his family history with access to immediate request for help.

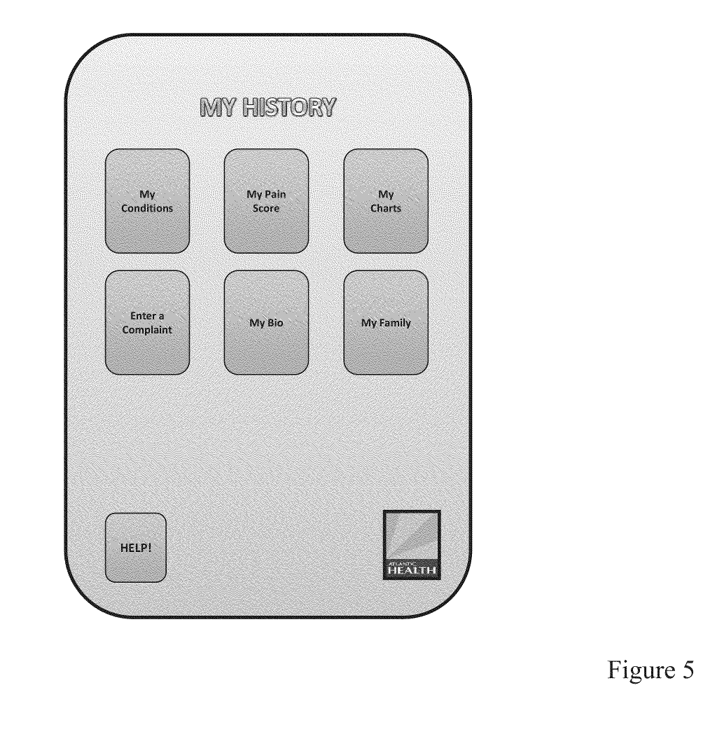

FIG. 6 depicts a representation of another of one of many next screens of the PCD depending on menu navigation, specifically in this instance, and again not by way of limitation, a “my schedule screen”, allowing the patient to access his schedule for the day, the week, the month, the year, his schedule of medications and scheduled doctor visits again with access to immediate request for help.

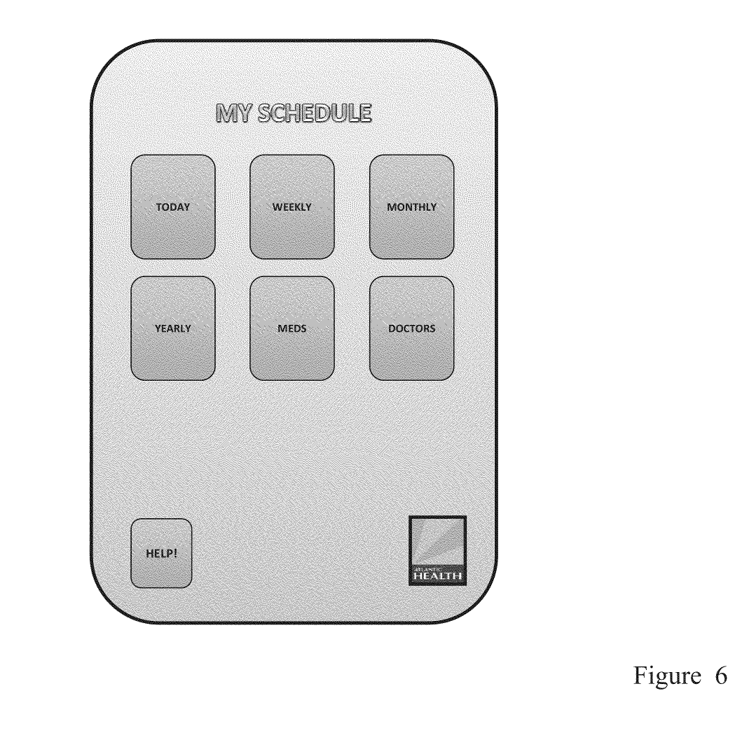

FIG. 7 shows another graphical representation of one embodiment of the system of the present invention. The individual components of the system are shown in black boxes detailing the availability of certain databases to certain access point users.

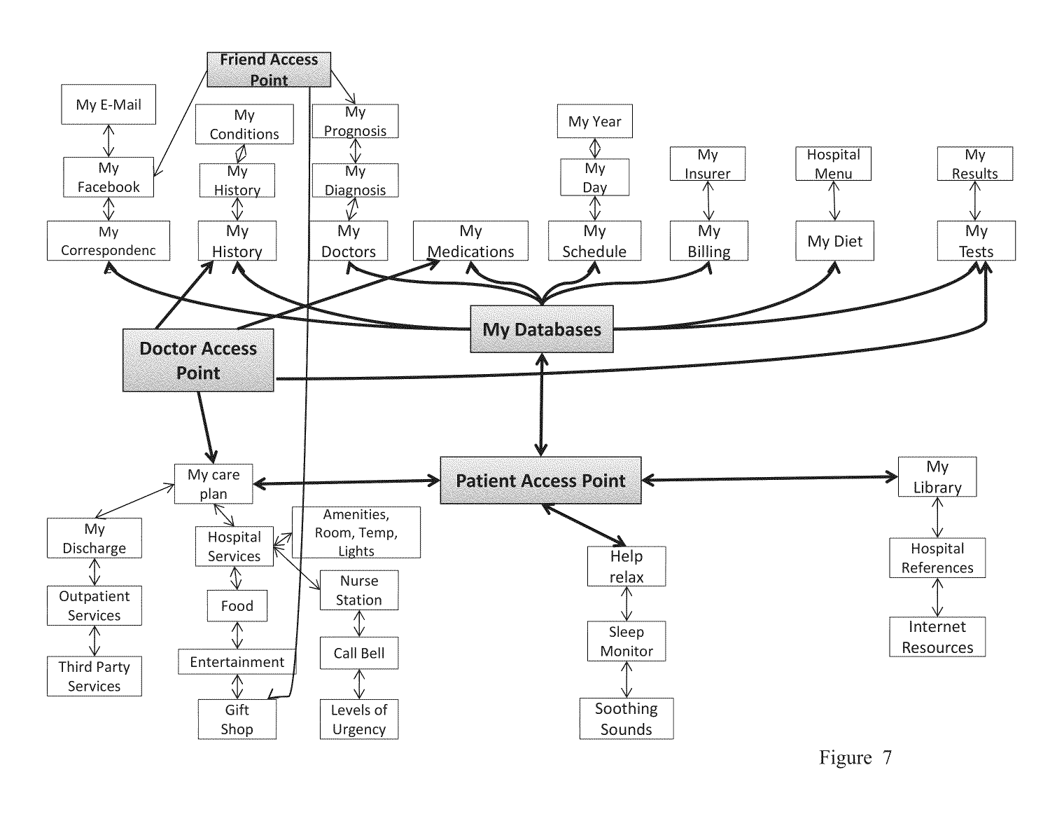

FIG. 8 shows a graphical representation of one embodiment of the system of the present invention. The individual components of the system are shown in black boxes. Examples of the features and/or information that are stored or available in the individual components are shown in grey.

FIG. 9 shows a graphical representation of one process by which an individual gains access to the system of the present invention and populates the system of the present information with information.

FIG. 10 shows a graphical representation of one possible mechanism by with the system of the present invention may be utilized.

FIG. 11 shows a graphical representation of one process by which an individual and his/her healthcare providers receive new information relating to the individual's pre-existing condition, based on the information the individual enters into the system of the present invention.

FIG. 12 shows a graphical representation of one process by which the system of the present invention may be utilized following an adverse reaction to the treatment an individual is receiving.

FIG. 13 shows another graphical representation of how the system of the present invention may be utilized.

### DETAILED DESCRIPTION

For clarity of disclosure, and not by way of limitation, the detailed description of the invention is divided into the following subsections that describe or illustrate certain features, embodiments or applications of the present invention.

### Definitions

“Electronic medical record”, or “EMR”, or “electronic health record”, or “EHR” as used herein refers to a computerized record, or any portion thereof, of the documentation of a patient's medical record.

“Healthcare provider” or “healthcare facility” as used herein means an organization, entity, or individual, such as, for example, a hospital, clinical laboratory, physician, physical therapist, outpatient service provider, home health care provider, insurance company, and the like, that provides any treatment or services related to the treatment of an individual.

The term “healthcare record” or “medical record” as used herein refers to the documentation of the body of information, or any portion thereof, that comprises a patient's individual medical history and care, including, but not limited to information sufficient to identify the patient, information on medical encounters, orders and prescriptions, history of the present illness/complaint, previous illnesses, diagnoses, prognoses, physical examinations, x-rays, lab test results, digital images of the patient, informed consent forms, insurance information, billing records, patient tendencies and the like.

“PHR” as used herein refers to an individual's personal health record.

“PHR records database” as used herein refers to an organized collection of personal health records.

### The System of the Present Invention

In one embodiment the present invention provides a system that allows an individual to manage, oversee and direct their healthcare comprising a patient interface and at least one node selected from the group consisting of:
a) an at least one patient healthcare record database;
b) an at least one healthcare facility database;
c) an at least one patient individual complaint database;
d) an at least one billing database;
e) an at least one other user interface;
f) access to hospital services; and
g) access to the internet;
   wherein the patient interface provides: (i) access to the at least one selected node; and (ii) continuous analysis based on the individual's input to all of the foregoing to provide output of likely critical and non-critical information to consider in formulating a diagnosis, plan of treatment, or other healthcare or personal decisions.

In one embodiment, the system of the present invention is used to generate a Continuity of Care Record (CCR). A CCR is a flexible document that contains the most relevant and timely core health information about an individual. The system of the present invention may send the CCR from one caregiver to another. The CCR may contain various sections such as patient demographics, insurance information, diagnoses and problem list, medications, allergies and care plan. These represent a “snapshot” of a patient's historical and current health data that can be useful or possibly lifesaving, if available at the time of clinical encounter.

In one embodiment, the system of the present invention enables individuals and their families or other third parties, where authorized, to become engaged in the individual's healthcare. Authorized third parties may be necessary in instances where the individual does not, or cannot accurately or adequately communicate or describe their problems and needs. Such instances may include, for examples, an inability to communicate due to illness, disability, an inability to speak the language, and the like.

In one embodiment, the system of the present invention improves the quality, safety and efficiency of an individual's healthcare and reduces disparities. The system of the present invention improves the coordination of an individual's care amongst their numerous healthcare providers. The system of the present invention allows for information about an individual and care of the individual to be seamlessly communicated amongst healthcare providers in different geographic locations. The system of the present invention improves the overall public health. The system of the present invention allows for evaluation of medication provided in the present, near past and distant past. The system of the present invention makes information capable of understanding from an elementary level of comprehension through a medical expert. The system of the present invention can translate the information into any language and decipher all recognized health records formatting and coding. The system of the present invention maintains the privacy and security of health information. Only certain authorized users can grant access to various levels of information contained within the various nodes.

In one embodiment, the system of the present invention allows the individual to access and modify information across multiple visits or treatments. The system of the present invention allows the comparison and merging of data with proper analysis and information output (such as, for example, insurance eligibility, claims, drug-drug interactions and the like). The system of the present invention enables the individual, or others to analyze the data for decision support (such as, for example, the treatment's effectiveness, risks, side effects, likely time to heal, likely prognosis, pain, etc., by condition and severity of condition, and the like).

In one embodiment, the individual is able to select their preferred language. The individual may also summon medical assistance. In one embodiment, the individual is able to select the urgency by which the individual desires assistance.

In one embodiment, the individual may communicate with others, such as, for example, healthcare professionals, family members, and the like. In one embodiment, the communication is electronic, by any suitable medium, such as, for example, email, telephone, video, and the like.

In one embodiment, the individual may enter and/or review at least one category of information selected from the group consisting of: Pain score, room temperature, mood, food/dietary need, schedules, checklists, the individual's care team, healthcare records, medications, tests, test results, emails, educational materials, care plan(s), discharge plan(s), and community care plan(s).

In one embodiment, the structure of the present invention is based on a client-server model, with the patient-side device operating as a client, and a computer or a series of computers elsewhere in the medical facility operating as the server.

Alternatively, the server, or any one or more node(s) of the server, could be located in the cloud.

In one embodiment, the patient interface is on a personal communication device “PCD”. In one embodiment, the PCD may take the form of a laptop, a tablet computer, a smart phone, or any other technology suitable as a function of its size to be located next to a hospital bed. There may be many PCD's capable of operating as a client. For example, one PCD may be operated by a physician. One PCD may be operated by a lab technician. One PCD may be operated by a friend or family member.

On the server side, multiple redundancies and administrative safeguards will ensure data storage integrity.

In one embodiment, the PCD will connect to the server via the Internet and to a health care provider's internal network (“LAN”) via a wireless connection protected by WPA2-Enterprise (802.11x) with strong 256-bit AES encryption or other suitable data secure technology. This level of network security ensures health record privacy and conforms to CFR Title 45, Part 164.312. The network will employ multiple redundant wireless access points to prevent network failure and protect the patient's (or other PCD user's) login session. This type of connection has an “always up” capability by ensuring that even if access to the public internet is down in case of an outage or an emergency, the patient can locate and review his or her locally-stored medical records, and access other functions of the present invention, such as the applications and the complaint database or other locally accessible databases.

In one embodiment, after the user is authenticated and logged in, the session is protected by automatic logoff, which is required by HIPAA (see CFR Title 45, Part 164.312). Either the client-side software or the wireless LAN or both will initiate automatic logoff to disconnect a user after a pre-configured period of time of inactivity.

In one embodiment, the PCD will contain the “front end” of each application—i.e. its graphical user interface portion which allows for display and for input from the patient or other PCD user, with the data stored and accessed on the server by the PCD user at that particular PCD user's level of accessibility. This will ensure data integrity in case of destruction or disablement of the PCD, or the need to simply borrow access from someone else's PCD. In that eventuality, a brand new PCD can simply be swapped in for the destroyed or disabled PCD, with no data loss, i.e., the proper login credentials will allow access to the corresponding level of database access. For example, the patient PCD login credentials will allow full access to all patient databases except those requiring professional license such as entering prescriptions and lab orders. An allowed physician PCD login credentials will allow access to all pertinent patient complaint and diagnosis and test result databases applicable to the complaint that that physician is responsible for treating. An allowed friend PCD login credentials may only allow access to certain “current patient status” databases. The patient determines the level of accessibility of all other PCD users with respect to his applicable databases. Further, since an individual PCD never stores any health records of a patient, these records cannot be compromised as a result of unauthorized access to the PCD by a third party.

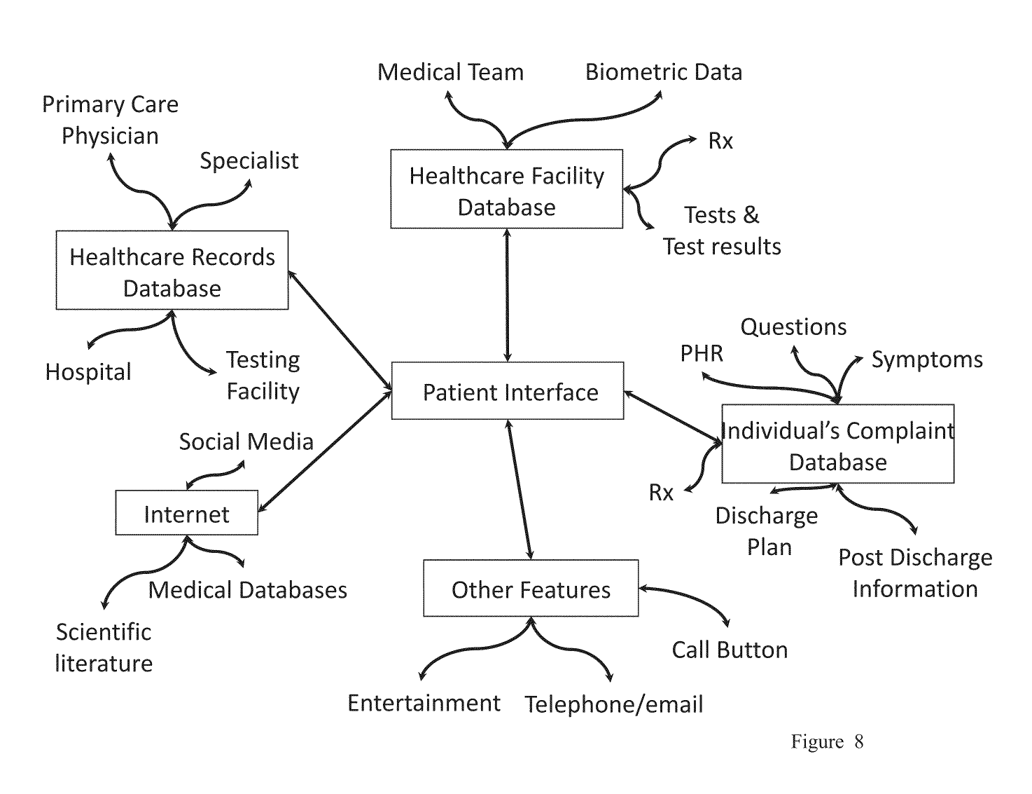

FIG. 8 shows a graphical representation of one embodiment of the system of the present invention. The individual components of the system are shown in black boxes. Examples of the features and/or information that are stored or available in the individual components are shown in grey. Central to the embodiment shown, is the patient interface, where an individual may receive and/or transmit information to or from the other components of the system. What is not shown, but can be readily appreciated by one of ordinary skill in the art, is the ability of information to be transmitted and/or received to or from any individual component of the system to any other. Such information exchange may be via the patient interface. Alternatively, the information exchange may not be via the patient interface.

The system of the present invention may be applied to any setting (such as, for example, a hospital, a long term care facility, a doctor's office, an individual's home or work place, and the like) and once information is entered, the system will always be updated to include in past history during the next setting visit. The choice of settings can be readily selected by one of ordinary skill in the art. Furthermore, the features and/or information that are stored or available in the individual components may be tailored specifically for any given setting, and the selection of features and/or information can be readily determined by one of ordinary skill in the art.

For example, in one embodiment, an individual may utilize the system of the present invention outside of a healthcare setting, and update information stored within the system, either regularly, or upon completion of a step, such as, for example, a vaccination, routine physical, enrollment in a support group, and the like. In one embodiment, the system of the present invention generates a CCR, containing the information entered by the individual, and sends the CCR to the individual's healthcare professionals. The CCR may be sent to one, or more than one of the individual's healthcare professionals.

In another example, an individual may utilize the system of the present invention in a public health emergency. Public health emergencies may include, for example, incidents of flooding, severe weather, disease outbreaks, anomalous pockets of health related activity, and the like.

In one embodiment, system of the present invention may alert the individual to a potential public health emergency, and provide relevant information to the individual and/or the individual's healthcare professionals, based in information pertaining to the individual that is stored and/or accessed on or by the system of the present invention. In an alternate embodiment, the individual may utilize the system of the present invention to search for information manually.

In an alternate embodiment, the present invention collects and assembles the health information from more than one individual and performs analysis on all the health information stored on the system. In one embodiment, the system of the present invention collects one individual's health information in real-time and compares the information with the health information of other individuals. In one embodiment, the comparison of the one individual's health information with the health information of other individuals provides real-time preventative and/or predictive analysis of public health emergencies. In one embodiment, the system of the present provides alerts, based on the comparison of the one individual's health information with the health information of other individuals. Depending on the nature of the public health emergency, the alert may be sent to the one individual, the other individuals, the local healthcare authorities, national healthcare authorities, or any combination thereof.

In one embodiment, in addition to the comparison of the one individual's health information with the health information of other individuals, the system of the present invention analyses the health information of the individual and the health information of other individuals statistically. In one embodiment, the statistical analysis provides additional accuracy to predicting public health emergencies.

In one embodiment, pharmaceutical companies may utilize the system of the present invention to predict supplies of drugs, vaccines, medical supplies, and the like.

It can be readily appreciated that the system of the present invention accesses information from multiple disparate sources, wherein the disparate sources may utilize different database architecture and/or languages. Issues with combining heterogeneous data sources under a single query interface have existed for some time. The rapid adoption of databases has led to the need to share or to merge existing repositories. This merging can take place at several levels in the database architecture.

For example, one solution involves data warehousing. In data warehousing, a warehouse system extracts, transforms, and loads data from heterogeneous sources into a single common queriable schema so data becomes compatible with each other. This approach offers a tightly coupled architecture because the data is already physically reconciled in a single repository at query-time. However, problems arise with the “freshness” of data, which means information in the warehouse is not always up-to-date. Combining heterogeneous data sources efficiently and accurately is essential, for example, to prevent loss of data, and to minimize cost.

In one embodiment, the system of the present invention provides continuity of information amongst the various sources of information by utilizing a service or software that facilitates the ubiquitous transfer of information, such as, for example, the service and software available under the tradename ION®.

While one of ordinary skill in the art can appreciate the many embodiments of the system of the present invention; for clarity, operation of the system of the present invention is described in detail below using the example of an individual managing, overseeing and directing their healthcare in a hospital setting.

### The Patient Interface

In one embodiment, the patient interface is a graphical user interface “GUI” by which the individual is able to utilize the system of the present invention. One of ordinary skill in the art can readily appreciate and construct a suitable GUI by which the individual may utilize the system of the present invention. The patient interface can access one, or more than one, or all of the other components of the present invention. The access may be unidirectional, either to or from the other component(s), or bidirectional, or any combination of the foregoing, with varying levels of security levels and protocols.

In one embodiment, the GUI is a touchscreen with multiple levels of menu choices whereby the patient chooses to access certain databases and/or services and/or the internet and within the same screen is provided the output requested by touching the requested menu choice.

In one embodiment, the GUI is activated with voice commands.

In one embodiment, the GUI may require input at certain intervals or, failing such input, report a possible emergency condition for response by emergency response team.

In one embodiment, the patient interface controls access to the system of the present invention. In one embodiment, the individual may only access the system of the present invention after the individual's identity has been verified. Verification may be via any suitable mechanism, such as, for example, entry of the individual's social security number, entry of a unique code, fingerprint verification and the like.

In one embodiment, the individual access and edits information stored on the system of the present invention via the patient interface. The individual may be the individual receiving treatment, a family member of the individual receiving treatment, a person designated by the individual, or any combination thereof.

In one embodiment, once the individual has been granted access to the system of the present invention, the individual has access to all the information and/or features of the system of the present invention.

In an alternate embodiment, the degree of access the individual has to the system of the present invention may be restricted. For example, the individual may only be granted access to a subset of the information and/or features of the system of the present invention. In one embodiment, the individual requires a subscription to access to all, or subsets of the information and/or features of the system of the present invention. In an alternate embodiment, the individual may select the features and/or information to which they desire access.

In certain embodiments, the ability of the individual to edit information contained within one, or more than one databases of the present information may be restricted. Such restriction may be necessary to maintain the integrity and/or security of the particular database(s) in question. For example, in one embodiment, the individual may access and search the health records that are maintained by the individual's healthcare provider(s) and healthcare facility in the at least one healthcare records database of the present invention. However, the ability of the individual to edit their healthcare records is prohibited.

In one embodiment, the individual may only enter, store and/or edit information in the at least one individual complaint database of the present invention, via the patient interface. The information entered, stored or edited in the at least one individual complaint database may be used to edit information stored in other components of the system of the present invention. In one embodiment, the information entered, stored or edited in the at least one individual complaint database may be used to edit information stored in other components of the system of the present invention only after being reviewed by a healthcare professional. In one embodiment, the healthcare professional manually edits the information stored in other components of the system of the present invention.

In one embodiment, the individual can access other features, such as, for example, communication services (email, telephone and the like), entertainment (for example, TV, radio, social media and the like). Access to other features may be unlimited, or, alternatively, restricted, requiring a subscription, for example.

In one embodiment, the patient interface further includes a call button, or other suitable mechanisms by which the individual may summon assistance, such as, for example, from a healthcare provider.

In one embodiment, the patient interface allows the individual to interact with a family member or other third party. In the case where a family member or other third party is able to interact with the system of the present invention, a separate login may be required.

In one embodiment, a healthcare professional is able to enter, store and/or edit information via the patient interface. In the case where a healthcare professional is able to enter, store and/or edit information via the patient interface, a separate login may be required.

In one embodiment, the patient interface may be in the patient's bed, such as for example, included as part of the hospital bed with nurse call system interface disclosed in U.S. patent application Ser. No. 13/356,906.

In an alternate embodiment, the patient interface may be a web-based application. Alternatively, the patient interface may be on a hand-held device, such as, for example, a smart phone or tablet.

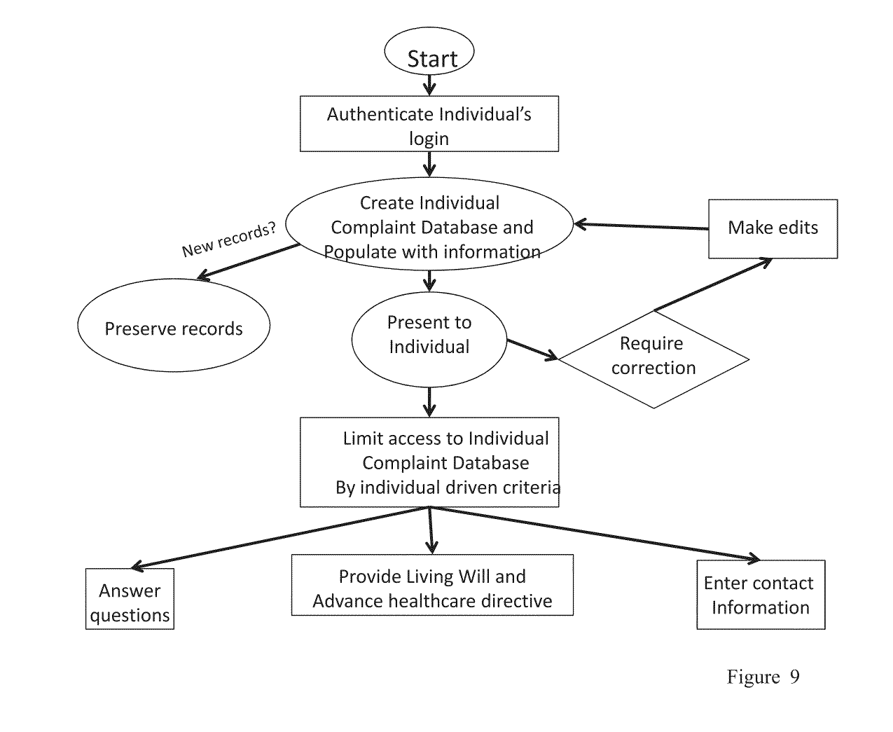

FIG. 9 depicts one possible mechanism by with the system of the present invention may be utilized. The individual logs into the system of the present invention by entering the requested verification information via the patient interface. The system of the present invention creates an at least one individual complaint database that is specific to the individual and is linked to the individual's patient interface. The system of the present invention then populates the at least one individual complaint database with information. The population of the at least one individual complaint database may be automatic, or, require input from the individual, the individual's healthcare provider, or any combination thereof

In the example depicted in FIG. 9, the system of the present invention prompts the individual to upload their personal health records via the patient interface. In one embodiment, the individual utilizes the patient interface to search for their personal health records. The individual may upload all or, alternatively a subset of their personal health records. The individual may also use the patient interface to highlight of flag portions of their personal health records. In instances where portions of the personal health records are flagged, the flags may serve to indicate items that the individual feels relevant to their complaint, or, alternatively, items which the individual may wish to discuss with others.

In the example depicted in FIG. 9, the system of the present invention prompts the individual to enter information sufficient to identify others whom the individual desires to play a role in the individual's healthcare via the patient interface. Such information may include, for example, the individual's living will or advanced healthcare directive. Alternatively, the information may include the names and contact information of the individual's relatives, legal guardians, and the like. The individual may restrict or modify degree of access that any of the other persons that the individual designates to the system of the present invention using the patient interface.

In the example depicted in FIG. 9, the system of the present invention populates the at least one individual complaint database with information from the individual's healthcare records. The system of the present invention preserves information from the individual's healthcare records for future access by caregivers or other individuals. The system of the present invention prompts the individual to verify and/or correct the information via the user interface. The system of the present invention may generate an alert if the individual verifies and/or corrects the information. Any or all nodes may be continuously updated with information, not just in connection with specific patient information, but also with general knowledge and advances in the field of medicine generally such that the most up to date clinical integration is possible of all nodes at any given point in time.

In the example depicted in FIG. 9, the system of the present invention prompts the individual to answer questions via the patient interface. The questions may be, for example, questions relating to the individual's health, symptoms, appetite, lifestyle, hobbies, sports and the like. The answers to the questions are then stored in the at least one individual complaint database.

In one embodiment, at least one other user is able to utilize the system of the present invention. Such at least one other user may include, for example, the individual's health care provider. The at least one other user may utilize the system of the present invention via the patient interface. Alternatively, the at least one other user may utilize the system of the present invention via an at least one other user interface. In one embodiment, the at least one other user interface is on a PCD.

In one embodiment, the at least one other user interface is a graphical user interface “GUI” by which the at least one other user is able to utilize the system of the present invention. One of ordinary skill in the art can readily appreciate and construct a suitable GUI by which the at least one other user may utilize the system of the present invention. The at least one other user interface can access one, or more than one, or all of the other components of the present invention. The access may be unidirectional, either to or from the other component(s), or bidirectional, or any combination of the foregoing, with varying levels of security levels and protocols.

### The Individual Complaint Database

In one embodiment, individual is able to enter information freely into the at least one individual complaint database. In alternate embodiment, the individual enters information in the form of answers to specific questions. The patient's attending physician may ask the questions. Alternatively, the questions may be pre-written questions.

In one embodiment, the information entered by the individual is stored on the at least one individual complaint database. In one embodiment, the information stored on the at least one individual complaint database is used by the system of the present invention to search for information. The system of the present invention may search one, or more than one, or all of the components of the present invention. Similarly, the at least one individual complaint database may be accessed by one, more than one, or all of the other components of the system of the present invention.

In one embodiment, the system of the present invention searches the patient's healthcare record for information. The parameters of the search may be based on the information stored on the at least one individual complaint database. Alternatively, the parameters of the search may be set by the individual, or, alternatively, the patient's medical advisers, such as for example, an individual's healthcare professional (such as, for example, the individual's attending physician) or any other appropriately trained person with access to the individual's information on the system of the present invention or alternatively or cumulatively, a family member or other loved one or independent consultant.

The information that is stored on the at least one individual complaint database may be the symptoms the individual is experiencing. Alternatively, the information may be the individual's prior or pre-existing medical conditions. Alternatively, the information may be questions that the individual has regarding their treatment or condition. Alternatively, the information may be all of the foregoing. In one embodiment, the information, combination of information or additional information generated by its analysis may generate an alert that is transmitted to a healthcare professional.

In one embodiment, the at least one individual complaint database may contain information that the individual's attending physician, or any other person with access to the individual's information on the system of the present invention has entered into the database. Such information may include, for example, articles or other reference material that the individual may wish to review, discharge instructions, test results, biometric data, prescriptions, information on the individual's complaint, support groups, common side effects, and the like.

In an alternative embodiment, the combination of at least one individual complaint database, the patient's PHR database, and other health care records databases include automated analysis means whereby articles or other reference material that the individual may wish to review, discharge instructions, test results, biometric data, prescriptions, information on the individual's complaint, support groups, common side effects, and the like are automatically generated.

In one embodiment, the individual may utilize the at least one individual complaint database to request information relating to the individuals responsible for conducting any or all tests that are being performed on the individual. The system of the present invention can search one, or more than one, or all of the components of the system of the present invention to locate the requested information and report it to the individual. The individual may then contact the individual responsible for a test directly and request further information, or, alternatively, discuss the test further.

In one embodiment, the at least one individual complaint database stores the individual's personal health records or PHR. PHR may comprise data including for example, data including for example, data relating to allergies and adverse drug reactions, chronic diseases, family history, illnesses and hospitalizations, imaging reports (such as, for example, X-rays, CT scans and the like), laboratory test results, medications and dosing, prescription records, surgeries and other procedures, vaccinations, observations of daily living (ODLs), and the like.

In one embodiment, the individual may collect PHR utilizing specialized applications. As used herein, specialized applications (“apps”) are websites, desktop applications, and mobile apps that perform at least one designated task. The individual may use one, or, alternatively more than one app.

In one embodiment, the at least one designated task is selected from the group consisting of: connecting with a healthcare provider, organization, improving fitness, community interaction, management of lab tests, management of medical records, management of medications, activities, emergency preparation, tracking health conditions, apps related to a specific condition (such as, for example, aging, diabetes, allergies, asthma, cancer, coronary disease, or mental health), and apps related to a medical device (such as, for example, blood glucose monitors, blood pressure monitors, EEG devices, or heart rate monitors).

In one embodiment, the information contained within the individual's PHR is stored electronically in a database, and is accessible by the system of the present invention. The individual may grant the system of the present invention access to all, or a subset of the information stored in the PHR database.

In one embodiment, the database of PHR's and/or the apps used are commercially available, such as, for example, the database and services offered by Microsoft Corporation, offered under the tradename HEALTHVAULT®.

In one embodiment, the individual is able to ask questions of their treating physician or other healthcare professional, including without limitation the persons responsible for performing any tests, the individual's attending physician, the individual's primary care physician, the individual's specialist physician, or any other person the individual may chose to designate. In one embodiment, the system of the present invention generates an alert once the individual asks a question.

In one embodiment, the various healthcare professionals that the individual employs are able to exchange information amongst each other using the system of the present invention. In one embodiment, the exchange of information is made in response to and/or based on the information stored in the individual complaint database. In one embodiment, the exchange of information improves the coordination of care between the various healthcare professionals that the individual employs.

In one embodiment, the individual is able to monitor the exchange of information. Such information exchange may be at the request of the individual, and may be to enhance the level of care the individual is receiving.

In one embodiment, the exchange of information is initiated by the individual's attending physician. In an alternate embodiment, the exchange of information is initiated by the individual's primary care physician. In an alternate embodiment, the exchange of information is initiated by the individual's specialist.

In one embodiment, the individual is able to access their at least one individual complaint database after the individual has been discharged from hospital, or after the individual has stopped receiving medical care for their complaint.

In one embodiment, the healthcare professionals employed by the individual are able to access the at least one individual complaint database after the individual has been discharged from hospital, or after the individual has stopped receiving medical care for their complaint. In one embodiment, the individual complaint database will continue to maintain a record of all complaints in order to allow post-admission caregivers and/or future pre-admission and during admission caregivers to view the record(s) and provide more effective, up to date, care recommendations and decisions.

In one embodiment, the information stored in the at least one individual complaint database is used to query one, or more than one of the other databases in the system of the present invention. In one embodiment, the query searches for information relevant to the individual's complaint. In one embodiment, the information relevant to the individual's complaint changes the patient's treatment. In one embodiment, the individual initiates the query.

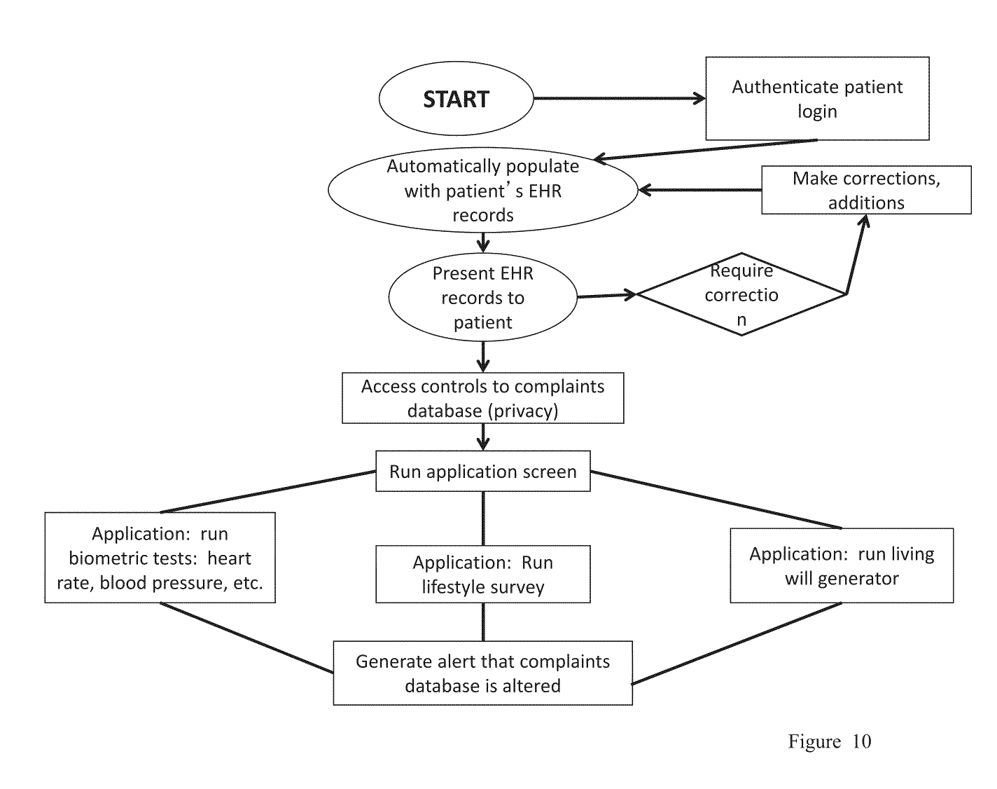

FIG. 10 depicts one possible mechanism by with the system of the present invention may be utilized. After the individual has logged onto the system of the present invention the system of the present invention creates an at least one individual complaint database that is specific to the individual and is linked to the individual's patient interface. The system of the present invention then populates the at least one individual complaint database with information. The population of the at least one individual complaint database may be automatic, or, require input from the individual, the individual's healthcare provider, or any combination thereof.

In the example depicted in FIG. 10, the system of the present invention prompts the individual to upload their personal health records onto the at least one individual complaint database via the patient interface. In one embodiment, the individual utilizes the patient interface to search for their personal health records. Such search may be via the internet, either to a website, or link to the individual's home computer of mobile device. Such a search is facilitated by the system of the present invention, via a dedicated internet access.

In the example depicted in FIG. 10, the system of the present invention prompts the individual to enter information sufficient to identify others whom the individual desires to play a role in the individual's healthcare, to be stored on the individual complaint database via the patient interface. Such information may include, for example, the individual's living will or advanced healthcare directive. Alternatively, the information may include the names and contact information of the individual's relatives, legal guardians, and the like. The individual may restrict or modify degree of access that any of the other persons that the individual designates to the system of the present invention using the patient interface.

In the example depicted in FIG. 10, the system of the present invention populates the at least one individual complaint database with information from the individual's healthcare records. The system of the present invention prompts the individual to verify and/or correct the information via the user interface. The system of the present invention may generate an alert if the individual verifies and/or corrects the information. The individual is able to review the information using the system of the present invention, and ask questions, or discuss the information, either in person, or via the system of the present invention.

In the example depicted in FIG. 10, the system of the present invention prompts the individual to answer questions via the patient interface. The questions may be, for example, questions relating to the individual's health, symptoms, appetite, lifestyle, hobbies, sports and the like. The answers to the questions are then stored in the individual's complaint database.

In the example depicted in FIG. 10, the individual is able to ask questions of the healthcare professionals employed by the individual. The system of the present invention is able to direct those questions to the relevant professional, based on the instructions of the individual.

In the example depicted in FIG. 10, the at least one individual complaint database is able to access and report information stored in the at least one healthcare facility database. Such information may include, for example, the team of persons employed in the individual's healthcare, biometric data (heart rate, blood pressure and the like), medications prescribed to the individual, test results and the like. Such information may also be stored on the at least one individual complaint database. The individual is able to review the information using the system of the present invention, and ask questions, or discuss the information, either in person, or via the system of the present invention.

In the example in FIG. 10, the information stored in the at least one individual complaint database is used to update the individual's healthcare records and/or PHR once the individual is discharged from hospital, or care for the individual complaint terminates. Such update may occur automatically, or may occur manually, via the individual's attending physician, for example. The system of the present invention generates an alert if the individual's healthcare records are updated.

The patient's healthcare records can be maintained by one or more than one of the patient's primary care physician, a specialist who is treating, or has treated the patient, a hospital, or diagnostic testing facility. In one embodiment, the healthcare records are electronic. The electronic healthcare records may be stored and managed on any system.

### The Healthcare Records Database

In one embodiment, the system of the present invention provides an at least one database of the patient's healthcare records. The database may be located on one, or more than one server.

For example, in one embodiment, the electronic healthcare records are stored and managed on the system disclosed in US Patent Application No. US20050187794A1.

In an alternate embodiment, the electronic healthcare records are stored and managed on the system disclosed in US Patent Application No. US20010049610A1.

In an alternate embodiment, the electronic healthcare records are stored and managed on the system disclosed in US Patent Application No. US20110119481A1.

In an alternate embodiment, the electronic healthcare records are stored and managed on the system disclosed in US Patent Application No. US20110119729A1.

In an alternate embodiment, the electronic healthcare records are stored and managed on the system disclosed in US Patent Application No. US20110153364A1.

In an alternate embodiment, the electronic healthcare records are stored and managed on the system disclosed in US Patent Application No. US20110119089A1.

In an alternate embodiment, the electronic healthcare records are stored and managed on the system disclosed in US Patent Application No. US20110106564A1.

In an alternate embodiment, the electronic healthcare records are stored and managed on the system disclosed in US Patent Application No. US20110004491A1.

In an alternate embodiment, the electronic healthcare records are stored and managed on the system disclosed in US Patent Application No. US20110004071A1.

In an alternate embodiment, the electronic healthcare records are stored and managed on the system disclosed in US Patent Application No. US20110153359A1.

In an alternate embodiment, the electronic healthcare records are stored and managed on the system disclosed in US Patent Application No. US20110099024A1.

In an alternate embodiment, the electronic healthcare records are stored and managed on the system disclosed in US Patent Application No. US20100030580A1.

In an alternate embodiment, the electronic healthcare records are stored and managed on the system disclosed in US Patent Application No. WO2009117655A2.

In an alternate embodiment, the electronic healthcare records are stored and managed on the system disclosed in US Patent Application No. US20100063845A1.

In an alternate embodiment, the electronic healthcare records are stored and managed on the system disclosed in US Patent Application No. WO2004051415A2.

In an alternate embodiment, the electronic healthcare records are stored and managed on the system disclosed in US Patent Application No. US20040078229A1.

In an alternate embodiment, the electronic healthcare records are stored and managed on the system disclosed in U.S. Pat. No. 7,275,220.

In an alternate embodiment, the electronic healthcare records are stored and managed on the system disclosed in US Patent Application No. US20020145634A1.

In an alternate embodiment, the electronic healthcare records are stored and managed on the system disclosed in US Patent Application No. US20020145634A1.

In an alternate embodiment, the electronic healthcare records are stored and managed on the system disclosed in U.S. Pat. No. 6,453,297.

In an alternate embodiment, the electronic healthcare records are stored and managed on the system disclosed in U.S. Pat. No. 5,644,778.

In one embodiment, the individual's healthcare records are freely exchanged amongst the individual's healthcare providers, and the system of the present invention provides the individual access to the records. In one embodiment, the individual's healthcare records are transportable across the care continuum, where any applications using said healthcare records will correspond to updated care and general knowledge. In one embodiment, the individual's healthcare records may be exchanged and integrated between healthcare providers and/or between nodes of the healthcare continuum so that care provided by one healthcare provider can be known and understood by another healthcare provider and/or by the patient.

In one embodiment, the individual's healthcare records are maintained on a central server. The central server may be located remote to the healthcare facility, or, alternatively, within the healthcare facility. In one embodiment, the individual's healthcare records are only accessible via the system of the present invention.

In one embodiment, the system of the present invention creates an at least one healthcare record database for the individual, and populates the database with all, or subsets of the individual's healthcare records. In one embodiment, at least one healthcare record database preserves an individual's healthcare records to allow caregivers across the health care continuum to understand the actions and decisions made during an individual's hospital stay and correspondingly provide more effective aftercare and/or future care.

In one embodiment, the patient has been admitted to a healthcare facility, such as, for example, a hospital, and the healthcare facility is able to update the patient's medical records, which the patient is able to monitor in real time.

Updates to the individual's healthcare records may be via direct input into the at least one healthcare record database, or via one, or more than one component of the system of the present invention. In one embodiment, the system of the present invention may only update the individual's healthcare records via the information stored within the at least one individual complaint database. In an alternate embodiment, the system of the present invention may only update the individual's healthcare records via the information stored within the at least one healthcare facility database. In an alternate embodiment, the system of the present invention may only update the individual's healthcare records via the information stored within either the information stored within the at least one healthcare facility database or the at least one individual complaint database.

In one embodiment, any change to the individual's healthcare records requires verification, to maintain the integrity, privacy and/or security of the individual's healthcare records.

In one embodiment, the system of the present invention is able to search the individual's healthcare records for information. The parameters of the search may be dictated by the individual, or via the information stored in the at least one individual complaint database. The information located may be used to modify the individual's treatment, or, alternatively, the individual may discuss the implications of the search with others. The system of the present invention is able to make the information capable of being understood by elementary level comprehension through a medical expert. The system of the present invention enables the information to be translated to and understood in at least one other language and/or the language understood at any one node of the system such that persons and/or other applications may understand all relevant information within all other nodes of the system pertinent to the use of that one node.

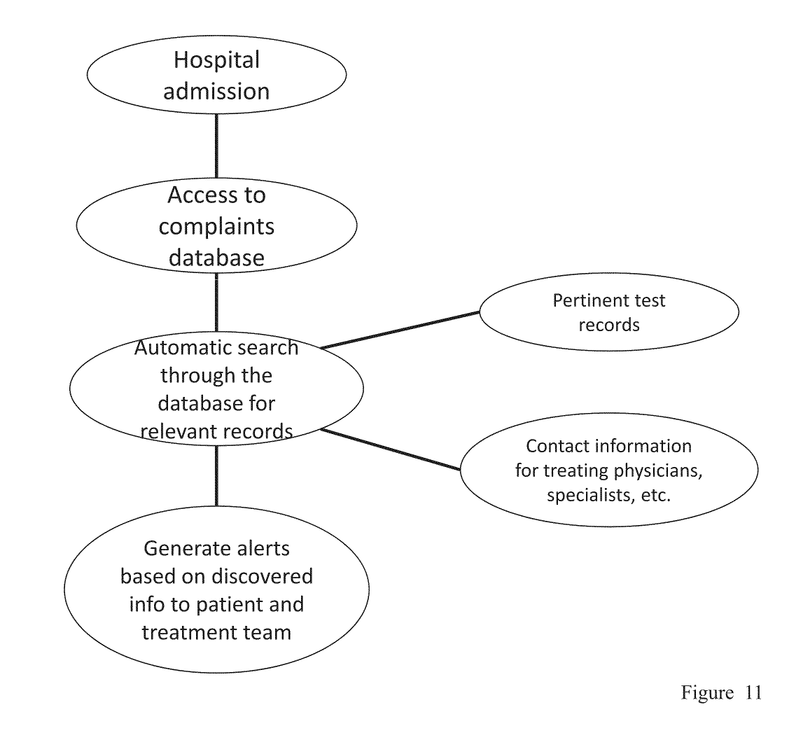

For example, using FIG. 11 for guidance, an individual is admitted to hospital for a torn rotator cuff. In the at least one individual complaint database, the individual indicates that he/she is diabetic. The system of the present invention searches the internet, the individual's PHR and the individual's healthcare records for information related to the individual's diabetes. Such information may include, for example, the individual's endocrinologist, the individual's blood glucose results for the past three months, or any possible adverse reactions observed in diabetic patients undergoing any proposed therapeutic intervention for a torn rotator cuff (such as impaired glycemic control following steroid injections, for example). The system of the present invention generates alerts, so that the individual, or others may review the located information.

### The Healthcare Facility Database

In one embodiment, the individual is in the care of a healthcare facility. The system of the present invention provides an at least one database wherein information pertaining to the healthcare facility is stored. Such information may include, for example, the persons tasked with the care of the individual, the schedules of such individuals, the individual's care plan, the individual's dietary choices, the individual's medical prescriptions, the individual's test and results. In one embodiment, the individual may access, but not edit the information stored within the at least one healthcare facility database.

In one embodiment, the at least one healthcare facility database may search one, or more than one, or all of the components of the present invention and store information located from the search. Such information may include, but not be limited to, for example, the individual's test results, information relating to the individual's complaint, information relating to the individual's other healthcare providers, information relating to the individual's other medical condition, information from the individual's complaint database corresponding to information flagged or located by the individual, or any combination thereof

The information relating to the individual's complaint may be the symptoms. Alternatively, the information may be the individual's medications, either the medications necessary to treat the complaint, or the medications that the individual is taking for a previous condition, or both. Alternatively, the information may be the individual's blood pressure, pulse, and the like. Alternatively, the information could be the individual's medical test results. Alternatively, the information could be the individual's treatment plan. Alternatively, the information could be the individual's discharge orders.

In one embodiment, the system of the present invention may update the individual's healthcare records via the information stored within the at least one healthcare facility database. In an alternate embodiment, the system of the present invention may only update the individual's healthcare records via the information stored within the at least one healthcare facility database. In one embodiment, any change to the individual's healthcare records requires verification, to maintain the integrity and/or security of the individual's healthcare records.

In one embodiment, the system of the present invention is able to search the at least one healthcare facility database for information. The parameters of the search may be dictated by the individual, or via the information stored in the at least one individual complaint database. The information located may be used to modify the individual's treatment, or, alternatively, the individual may discuss the implications of the search with others.

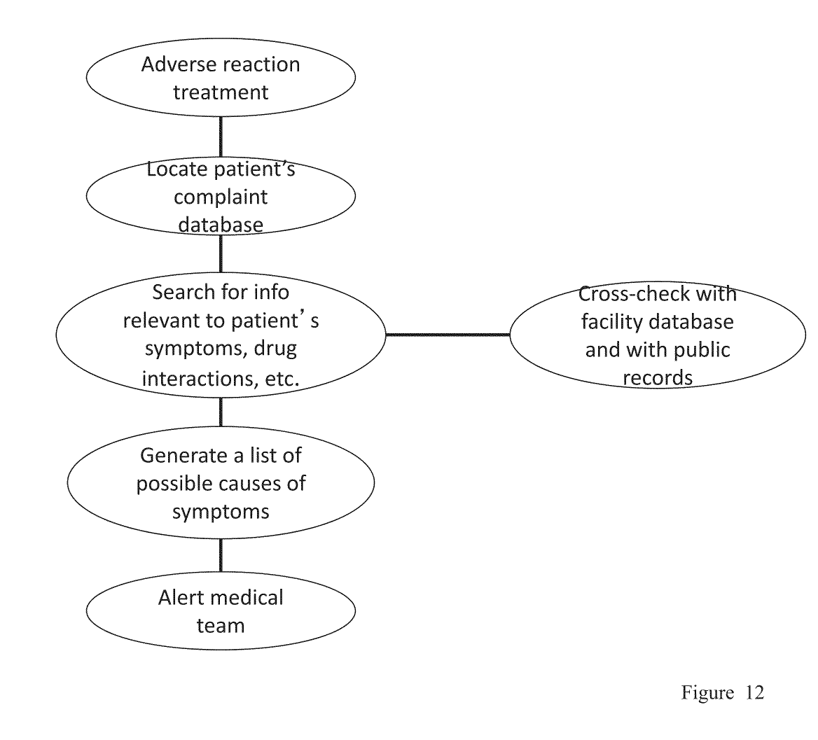

For example, using FIG. 12 for guidance, the same individual discussed in FIG. 11 above that was admitted to hospital for a torn rotator cuff experiences an adverse reaction to the treatment he/she is receiving. In the individual complaint database, the individual indicates that he/she is diabetic. The system of the present invention searches the internet, the individual's PHR, the individual's healthcare records, and the at least one healthcare facility database for information related to the individual's diabetes. Such information may include, for example, the individual's endocrinologist, the individual's blood glucose results for the past three months, the individual's current therapy and any biometric data taken whilst the individual has been undergoing treatment. The information located may be used to modify the individual's treatment, or, alternatively, the individual may discuss the implications of the search with others.

In one embodiment of the present invention, all of the foregoing component parts and resources are connected and automatically analyzed and programmed to generate prevention, diagnosis, treatment and prognosis recommendations; including, but not limited to, for example: (a) an analysis of the patient EHR and current symptoms to recommend articles related to those symptoms, preventative measures to be taken and treatment to be sought, if necessary or desirable; (b) alerts and recommendations generated in response symptom progression and changes in conditions; (c) diagnosis, treatment and prescription recommendations generated in response to and concurrent with treatment regimens; and (d) recommendations generated by virtue of patient's reaction to treatment regimen; (e) recommendations for post treatment conduct and monitoring for relapse and subsequent necessary treatment; and (f) continued and ongoing analysis of patient EHR and current symptoms and conditions to recommend articles related to those symptoms, preventative measures to be taken and treatment to be sought, if necessary or desirable.

### Hospital Services and the Internet

In one embodiment, the individual may access certain hospital services through the patient interface. For example, the individual may summon the nurse on call to the patient's room. For example, the individual may order available menu choices based on their individual dietary restrictions. For example, the individual may access a movie on television.

In one embodiment, the individual may access certain social media accounts such as a service known as FACEBOOK® wherein the individual can allow selected others to be updated as to the individual's current condition.

In one embodiment, others may reciprocate by offering get-well wishes and/or ordering gifts from the hospital gift shop or other service providers.

In one embodiment, there is provided a direct video link through, for example through existing service providers such as SKYPE® or FACETIME®, whereby the individual may share a video chat with a healthcare provider, family member or other selected third party.

In one embodiment, the individual may simply “surf the net” or access personal data repositories, such as email, and the like.

In one embodiment, queries in one node, for example, within the healthcare facility database, may automatically query databases within another node, for example, the internet.

In one embodiment, certain patient healthcare database entries may trigger alerts to public authorities where certain outbreaks may be occurring based on multiple similar entries across disparate patient databases.

The present invention is further illustrated, but not limited by, the following examples.

### Examples

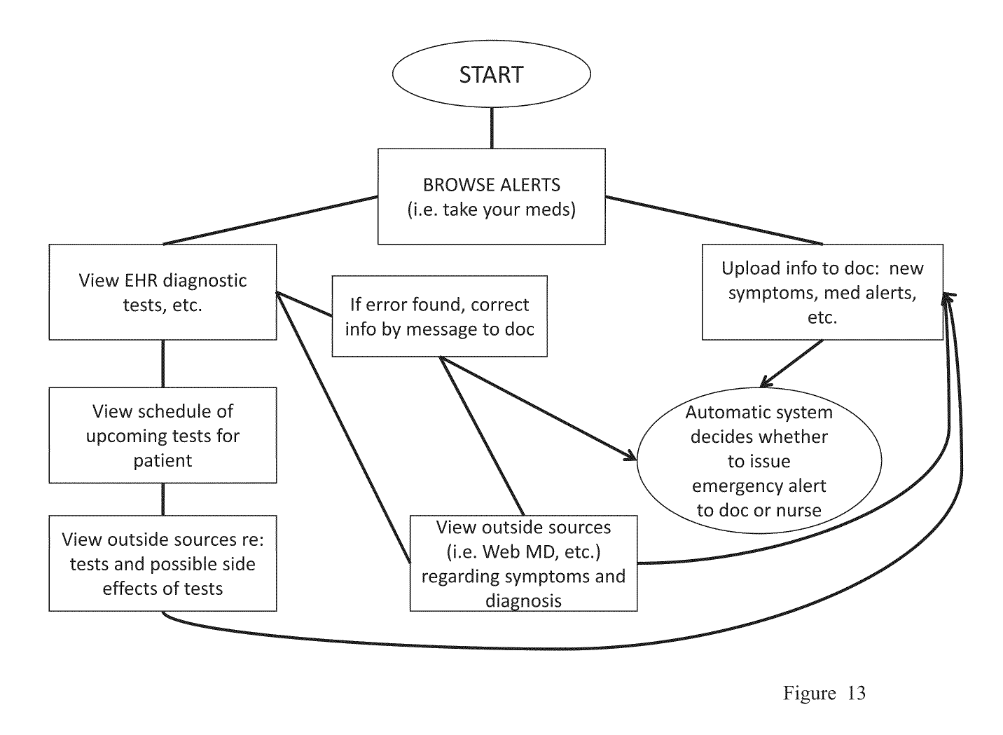

Referring to FIG. 13, the present invention provides a graphical user interface (“GUI”) suitable for an interactive doctor-patient relationship, wherein the patient can both learn additional information about his or her diagnosis, prognosis, and treatment, and inform the treating professionals of his or her concerns and questions. In one embodiment, the GUI is presented to the user via a bedside terminal in an inpatient setting, and can be activated by either standard keyboard-and-mouse controls, or an alternate voice control interface.

Upon launch of the GUI, the patient is presented with messages from the clinical staff and reminders, both staff-inputted and machine-generated. These messages can instruct the patient to take his medicine at a certain time, for instance, or to remember his or feet elevated. It can also remind the patient to expect a visitor at a certain time, or to call home.

At that time, the patient will have a choice to browse his electronic personal medical records (“PHR”) or to proceed to insert his information into the “complaint queue” for later review by medical professionals. The “complain queue” is used to store patient-provided information about symptoms, side effects, drug interactivity, and other treatment concerns.

The patient can browse the PHR to ensure its completeness, and ensure that all relevant information, such as allergies to medication and disease history is complete and correct. In case the patient needs to update his PHR record, he may not do so directly, but must enter a request into the complaint queue. From the PHR records, the patient may also access outside sources, such as WEBMD®, to learn more about his condition and the treatment currently prescribed by the medical professional.

The patient can also learn more about upcoming treatment modalities, such as testing and the introduction of new medication by accessing a personalized treatment calendar, and then likewise access outside sources to get more information on these issues. Any questions or comments are once again directed into the complaint queue.

At the end of the session, either a machine or a staff member reviews comments submitted by the patient and decides whether or not to alter the course of treatment based on the patient's input submitted into the complaint queue, and whether or not to provide more information to either the patient or the treating physician.

Publications cited throughout this document are hereby incorporated by reference in their entirety. Although the various aspects of the invention have been illustrated above by reference to examples and preferred embodiments, it will be appreciated that the scope of the invention is defined not by the foregoing description but by the following claims properly construed under principles of patent law.

Each and every feature described herein, and each and every combination of two or more of such features, is included within the scope of the present invention provided that the features included in such a combination are not mutually exclusive.

What is claimed is:

1. A system that allows an individual to manage their healthcare comprising a patient interface and an at least one node selected from the group consisting of:
a. at least one patient healthcare record database;
b. at least one healthcare facility database;
c. at least one patient individual complaint database;
d. at least one billing database;
e. at least one other user interface;
f. access to healthcare facility services; and
g. access to the internet;
wherein the patient interface provides: (i) access to the at least one selected node; and (ii) continuous analysis based on the individual's input to all of the foregoing to provide output of likely critical and non-critical information to consider in formulating a diagnosis, plan of treatment, or other healthcare or personal decision.

2. The system of claim 1, wherein the patient interface is an application on a personal communication device.

3. The system of claim 1, wherein two or more nodes are selected.

4. The system of claim 1, wherein the individual utilizes the patient interface to access information stored on the system.

5. The system of claim 1, wherein the individual utilizes the patient interface to access information stored on the internet.

6. The system of claim 1, wherein the individual utilizes the patient interface to access and request healthcare facility services.

7. The system of claim 1, wherein the healthcare facility is a hospital.

8. The system of claim 1, wherein the healthcare facility services are selected from the group consisting of: entertainment services, food, email, telephone service, social media, messages, nursing services, and physician visitation.

9. The system of claim 1, wherein the individual has read only access to at least one selected node accessed via the system of the present invention.

10. The system of claim 1, wherein read-write access to at least one selected node requires a verification step, prior to any access to or change to information stored therein.

11. The system of claim 10, wherein only the individual's healthcare provider may make changes to selected information stored in at least one node.

12. The system of claim 10, wherein the information contained within at least one selected node may be translated into alternate languages or alternate formatting or medical coding.

13. The system of claim 1, wherein the at least one selected node contains at least one PHR records database.

14. The system of claim 13, wherein the at least one PHR records database preserves all previously-entered records.

15. The system of claim 14, wherein the at least one PHR records database may be accessed by a healthcare provider regardless of geographic location of said healthcare provider.

16. A method of empowering an individual to manage, oversee and direct their healthcare by performing the steps of accessing the system as described in claim 1 via said patient interface and further accessing an at least one selected node and further viewing said information accessed and thereafter using said information to analyze a diagnosis, plan of treatment, or other healthcare or personal decision.

17. A method of detecting and responding to public health emergencies by performing the steps of accessing the system as described in claim 1 via said patient interface and thereafter coordinating and analyzing data contained in more than one system as described in claim 1.

18. A method of predicting public health emergencies by performing the steps of accessing the system as described in claim 1 via said patient interface and thereafter coordinating and analyzing data contained in more than one system as described in claim 1.
